(19) United States
(12) Patent Application Publication
(10) Pub. No.: US 2025/0107678 A1
(43) Pub. Date: Apr. 3, 2025

(54) INTEGRATED DUST SEPARATOR SYSTEM

(71) Applicant: Thomas HUNTLEY, Auburn Hills, MI (US)

(72) Inventors: Thomas HUNTLEY, Auburn Hills, MI (US); Joseph Andrew HUNTLEY, Greenville, SC (US)

(73) Assignee: FASTER BETTER EASIER, LLC, Orion Township, MI (US)

(21) Appl. No.: 18/725,511

(22) PCT Filed: Jan. 5, 2023
(86) PCT No.: PCT/US2023/010251

§ 371 Date: Jun. 28, 2024

Related U.S. Application Data
(60) Provisional application No. 63/296,653, filed on Jan. 5, 2022.

(51) Int. Cl. A47L 9/14; A47L 5/36; A47L 9/16

(52) U.S. Cl. CPC A47L 9/1418; A47L 5/365; A47L 9/1683

(57) ABSTRACT

A particulate matter separation system includes a particulate matter collection container defining a lower chamber; a particulate matter separator inside of a housing defining an upper chamber; and a bag assembly attachable to the collection container and the housing, the bag assembly comprising a body having a pressure equalization system structured as a labyrinth of channels internal to the body, the labyrinth communicating with one or more openings in the lower chamber and one or more openings in the upper chamber.

### CROSS-REFERENCE TO RELATED APPLICATIONS

This application claims the benefit of U.S. provisional application Ser. No. 63/296,653 filed Jan. 5, 2022, the disclosure of which is hereby incorporated in its entirety by reference herein.

### TECHNICAL FIELD

The present disclosure relates to an insert and a bag assembly arranged for incorporation within a wet/dry vacuum, the insert being configured to remove particulate matter from particulate-laden air, and the bag assembly being configured to collect the particulate matter.

### BACKGROUND

Clean air has become a priority for large industries as well as households and workshops. In settings such as crafts workshops, a variety of particulate material may be generated which may adversely affect the air quality present in the workshops. A number of devices have been developed to address the need to remove particulate material from air in such locations and environments, with various degrees of success. The devices are generally called dust collectors or dust separators.

### SUMMARY

In one or more embodiments, a particulate matter separation system is disclosed. The system may include a particulate matter collection container defining a lower chamber, a particulate matter separator inside of a housing defining an upper chamber, and a bag assembly attachable to the collection container and the housing, the bag assembly comprising a body having a pressure equalization system structured as a labyrinth of channels internal to the body, the labyrinth communicating with one or more openings in the lower chamber and one or more openings in the upper chamber. The separator may be a cyclonic separator. The body may include a set of coordinating concentric rings which cooperate with one another to form the labyrinth. The system may also include a collection bag secured within the bag assembly. The system may also include a shop vacuum motor head attachable to the housing. The system may include one or more filters within the upper chamber. The body of the bag assembly may include a support for the separator. The body of the bag assembly may include a top subassembly compatible with a bottom subassembly. The subassemblies may be repeatedly separable.

In one or more embodiments, a bag assembly is disclosed. The bag assembly may include a body securable to a vacuum system, the body having an upper surface and a lower surface, the surfaces each having an opening and the body having a pressure equalization system comprising one or more channels communicating with the openings. The bag assembly may also include a bag retaining component securably adjacent to the body and configured to secure a collection bag within the assembly when the bag retaining component is secured to the body. The opening may extend into a vertical channel. The vertical channel may extend into a horizontal channel. The system of channels may include one or more grooves. The body may include at least two body portions. Each body portion may have a channel portion aligned with the other channel portion to form at least a portion of the one or more channels. The body may form a unitary piece free of seals or fasteners. The system may also include one or more seals.

In one or more embodiments, a bag assembly may be disclosed. The bag assembly may include a body defined by two or more aligned portions forming a pressure equalization system including a labyrinth of one or more channels internal to the body and a bag retaining component arranged adjacent to the body and configured to secure a collection bag within the assembly. The one or more portions may include coordinating concentric rings which cooperate with one another to form the labyrinth. The portions may include a top subassembly compatible with a bottom subassembly. The subassemblies may be repeatedly separable.

In one or more embodiments, a particulate matter separation system is disclosed. The system may include a particulate collection container with an open top forming a lower chamber, an insert removably attachable to the collection container, the insert defining an upper chamber, the insert housing a particulate matter separator having a separator plate at a bottom portion of the particulate matter separator such that the separator plate divides the lower chamber from the upper chamber. The system may also include a shop vacuum motor portion removably attachable to a top portion of the insert.

The system may also include a collection bag and a bag assembly attachable between the collection container and the insert. The bag assembly may include a body having a pressure equalization system structured as a labyrinth of channels internal to the body and a component configured to secure the collection bag within the assembly. The particulate matter separator may form an integral part of the insert such that the insert's housing forms at least some portions of the separator. The system may also include one or more seals to provide an airtight system. The insert may include one or more filters. The bag assembly may include one or more portions or subassemblies. The bag assembly may be a unitary piece.

In one or more embodiments, an insert for a shop vacuum is disclosed. The insert may be removably attached between a collection vessel and a motor portion of a shop vacuum. The insert may serve as a housing for a dust separator incorporated within the housing. The housing may include a slanted portion extending from the bottom portion of the housing, with the slanted portion forming a nest to accommodate the dust separator.

In one or more embodiments, a kit including a number of pieces configured to be assembled into the insert is disclosed. The kit may include a disassembled housing having one or more horizontal portions, one or more vertical portions, or both. The kit may further include one or more pieces configured to assemble an edge surface of the bottom side of the housing, one or more pieces configured to assemble an edge surface of the top side of the housing, and one or more fasteners to attach a dust separator to the edge surface of the bottom side. The kit may further include one or more of the following: a sealant, assembly instructions, a dust separator.

In one or more embodiments, a unitary insert configured as a dust separator with a housing extending on the sides is disclosed. The unitary insert may be free of any seams and/or fasteners. The housing may be configured to be secured between a collection vessel and a motor portion of a shop vacuum. The unitary insert may include a separation plate attached to the bottom portion of the unitary piece.

In one or more embodiments, a unitary piece encompassing the separator and the bag assembly is disclosed. The unitary piece may include a separatation plate. The unitary piece may include a filter. The unitary piece may form an upper chamber of a system having a lower chamber formed by the separation plate and a collection container.

### BRIEF DESCRIPTION OF THE DRAWINGS

FIG. 1 depicts a perspective view of a non-limiting example of a commercially available shop vacuum;

FIG. 2 depicts a perspective view of a commercially available shop vacuum, having a collection vessel and a motor portion, and an insert, in accordance with one or more embodiments disclosed herein, housing a dust separator disclosed herein, the insert being secured between the collection vessel and the motor portion;

FIG. 3 shows a top perspective view of the insert shown in FIG. 2;

FIG. 4 shows a perspective bottom view of the insert shown in FIG. 2;

FIG. 5 depicts an alternative embodiment of a non-limiting example of an insert, attached to a commercially available shop vacuum, as disclosed herein;

FIG. 6A shows a top view of a bottom portion of the insert shown in FIG. 5 with an incorporated non-limiting example of a dust separator;

FIG. 6B shows a bottom view of a bottom portion of the insert shown in FIG. 5 with an incorporated non-limiting example of a dust separator;

FIG. 7A shows a bottom view of a top portion of the insert shown in FIG. 5;

FIG. 7B shows an alternative bottom view of the top portion and the housing of the insert shown in FIG. 5;

FIG. 7C shows a perspective view of the top portion and the housing of the insert shown in FIG. 5;

FIG. 7D shows a detailed view of the top portion of the insert shown in FIG. 5 with a motor portion of a shop vacuum protruding through the top portion;

FIG. 8 shows a cross-sectional view of a non-limiting example of a unitary insert configured as a dust separator according to one or more embodiments disclosed herein;

FIGS. 9A and 9B are perspective views of openings for connection of the insert with a dust separator incorporated within the insert;

FIG. 10 shows a non-limiting example of a kit or collection of parts configured to be assembled into the insert disclosed in FIG. 5;

FIG. 11 shows the insert assembled from the kit shown in FIG. 11;

FIG. 12 shows an alternative embodiment of the system including the separator placed between the first and second portions of a shop vac;

FIG. 13A shows a schematic view of a system disclosed herein with a bag assembly according to one or more embodiments, the system being in an open position;

FIG. 13B shows the system of FIG. 13A in a closed position;

FIG. 14 shows a cross-sectional partial view of a portion of a non-limiting example of a bag assembly including the internal pressure equalization system;

FIG. 15 shows a cross-sectional partial view of a portion of another non-limiting example of a bag assembly including the pressure equalization system;

FIG. 16 shows a perspective cross-sectional partial view of a non-limiting example of a bag assembly according to one or more embodiments disclosed herein;

FIG. 17 shows a perspective top view of a complete bag assembly of FIG. 16;

FIG. 18 shows a perspective bottom view of the bag assembly of FIG. 16;

FIG. 19 is a bottom perspective exploded view of the bag assembly of FIG. 16;

FIG. 20 is a top perspective view of a bottom subassembly ring of the bag assembly of FIG. 16;

FIG. 21 is a bottom perspective view of a top subassembly ring of the bag assembly of FIG. 16;

FIG. 22A shows a non-limiting example of a system including a low-profile cyclonic separator and a bagger assembly disclosed herein;

FIG. 22B shows a non-limiting example of a system including a low-profile cyclonic separator and a secondary foam filter within an insert, and a bagger assembly disclosed herein;

FIG. 22C shows a non-limiting example of a system including a conventional cyclonic separator and a bagger assembly disclosed herein;

FIG. 22D shows a non-limiting example of a system including a low-profile cyclonic separator, a secondary filter, an additional filter, a shop vac motor portion, and a bagger assembly disclosed herein;

FIG. 23 is a perspective front cross-sectional view of a non-limiting example system including a collection container, bag assembly, and insert housing a separator and a filter;

FIG. 24 is a partial cross-sectional view of the bag assembly shown in FIG. 23; and

FIG. 25 shows a non-limiting embodiment of a bag assembly structured as a unitary piece.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise” “consist of,” and/or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The devices tasked with cleaning air laden with particulate matter in a workshop setting are traditionally classified as dust separators. Many of the devices use centrifugal force as a primary means of separating debris from dust-laden air. The dust separators are commercially referred to as cyclonic or centrifugal particulate collectors or separators. The dust separator is connected to a wet/dry vacuum, also called a shop vacuum or shop vac.

For decades, the typical shop vacuum has been a device that draws dust-laden air into a drum or similar container where the dust-laden air encounters a filter. Once the filter stops the flow of dust and debris of the dust-laden air, gravity causes the dust and debris to fall into a container for disposal. Mostly clean air then passes through the filter, and later out of the vacuum and back into the atmosphere. To extend the operating life of the filter(s), which are typically quite expensive, especially in the long run, and can get clogged up fast, pre-separation devices for removal of dust and debris upstream from the vacuum's filter(s) may be used. An example device may be one of the dust separators mentioned here.

The connection between the shop vacuum and the dust separator is usually established via one or more hoses and/or elbows. Additional hoses and/or elbows may be used to connect a debris-generating tool to the dust separator. The dust separator not only cleans the air for the user, but it also extends the life of the dry/wet vacuum motor, filter, or both.

Yet, the connection via hoses and elbows may be cumbersome, increasing complexity of a working area. Additionally, when not in use, the hoses take up valuable storage space which is typically in high demand in a workshop. With the ever-increasing interest regarding spatial efficiency, safety, and simplification, there is a need for a compact air-cleaning system for various types of workshops.

Additionally, the collected dust typically lands in a collection bucket which has to be periodically emptied and cleaned. Because the dust and debris are exposed when the collection container is disconnected from the separator, the removal may result in reintroduction of at least a portion of the collected dust to the cleaned environment and time and effort is typically spent on cleaning of the collection container. Disposal of the collected dust thus remains to be a disordered part of the operation.

Attempts have been made to include a plastic bag as a liner for the collection container. But due to the suction/vacuum present in the system, a simple placement of the bag does not work. When a plastic bag is placed in the collection container under a separator, the bag does generally get sucked into the separator within a matter of seconds. If the fit between the bag and the collection drum is compressed to eliminate the leaks, another problem arises in that the air between the outside of the bag and the inside of the collection container is trapped such that the bag does not deploy to its full volume. As a result, the amount of dust a plastic bag can hold is limited, and its use may be impractical. Thus, there is a need to provide a collection container system structured to accommodate a plastic bag in such a way that the plastic bag works as a practical dust and debris collector.

In one or more embodiments, an integrated particulate matter removal system is disclosed. The system may include an insert for a dry/wet vacuum or shop vacuum. The insert addresses one or more problems described above.

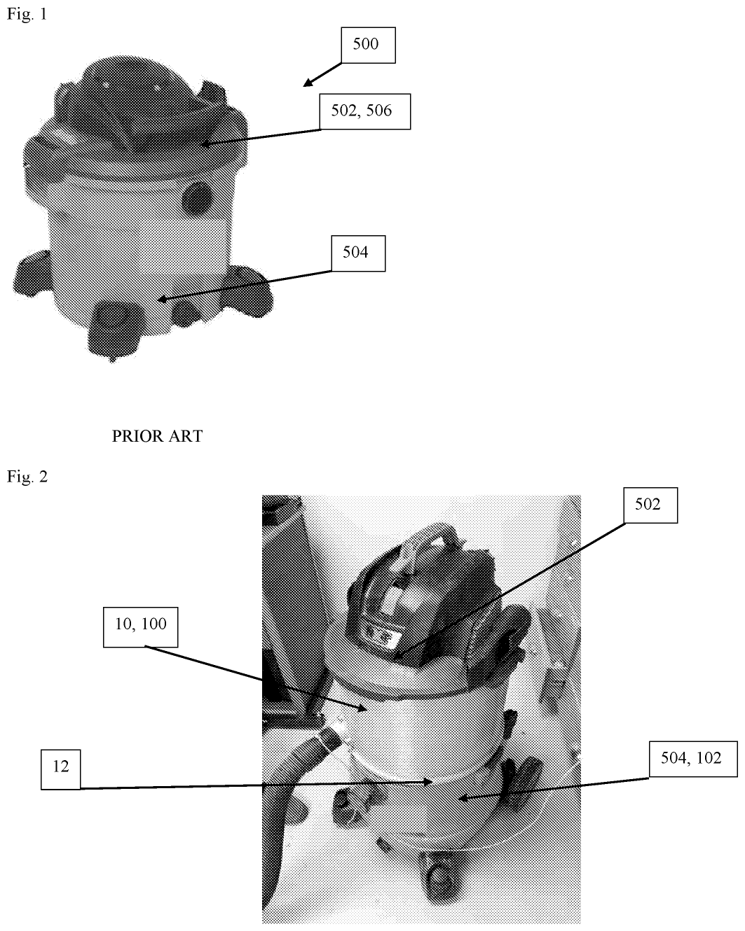

The insert is a device configured to be included between two portions of a shop vacuum 500, a non-limiting example of which is shown in FIG. 1. The shop vacuum, as described in this disclosure, is not limited to any specific type of a shop vacuum. The shop vacuum may be any dry/wet vacuum intended for collection of debris and/or material in a working setting. For example, the dry/vac vacuum may be a dry/wet vacuum configured to collect material in a wood working shop, construction shop, dental workshop, jewelry, arts and/or crafts shop, but also a medical setting, glass workshop, metal working environment, and/or other environments, in which particulate material needs to be collected and disposed of. The material may include one or more types of material. The type of material is not limited and may include dust, debris, refuse, offal, rubble, organic material, non-organic material, metal, glass, plastic, wood, plant material, bone, tissue, cement, paper, or a combination thereof.

While the insert 10, 10′ is predominantly described as a portion between the collection container 504 and the shop vac motor portion 502, the insert 10, 10′ in a broader sense may be a housing for a separator 50, a secondary filter 300, or both. The insert 10, 10′ may be enclosable with a top or a lid, which may be removable and/or replaceable with the shop vac first portion 502. In some embodiments, the shop vac first portion 502 may not be included. In some embodiments, the insert 10, 10′ may be placed between a collection container 504 and a secondary filter housing. In other embodiments, the insert 10, 10′ may be attached to a collection container 504, bag assembly 70, or both. In some embodiments, the system may include the insert sandwiched between the shop vac first portion, a secondary filter housing and a collection container, stackable, and removably attachable in various order.

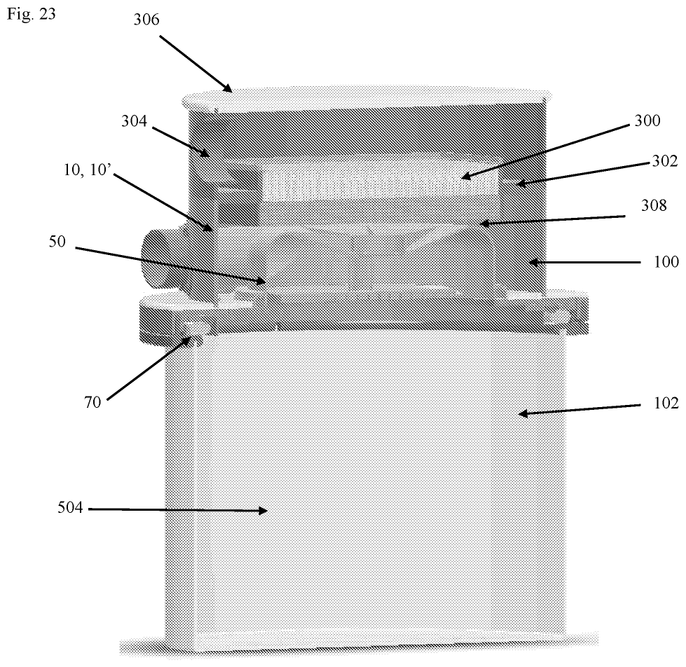

The insert or housing 10, 10′ may include the separator 50, a secondary filter 300, or both. The secondary filter 300 may be any additional filter arranged to fit in the insert 10, 10′. In a non-limiting example, the filter 300 may be a pleated filter, open cell foam filter, a rubber filter, or a combination thereof. The filter 300 may be housed within the insert 10, 10′ in a slot, on a platform, or otherwise. The filter 300 may be located adjacent to, immediately adjacent to, and/or above the separator 50. A gap 308 may be formed between the separator 50 and the filter 300. A non-limiting example of a system including the insert 10, 10′ housing the separator 50 and the filter 300 is shown in FIG. 23.

As is illustrated in FIG. 1, the shop vacuum 500 may include a first portion, housing a motor 506, and a second portion, housing a collection container or chamber 504. The second portion 504 may be any vessel, chamber, container, bucket, can, canister, pail, pot, enclosure, cell, semi-enclosed, or fully enclosed space arranged to collect a material which is being removed from the environment of a workshop or area via use of the shop vacuum. The second portion 504 may match the brand or type of the instrument's first portion such as be a part of the same shop-vac system. Alternatively, the first and second portions 502, 504 may be commercially or otherwise unrelated such as the first portion may be a type of a shop vac with a motor from one system, manufacturer while the second portion may be a collection vessel from a different system, manufacturer, etc. An example of such embodiment is shown in FIG. 11.

As is shown in FIG. 2, the insert 10 disclosed herein may be attached between the first portion 502 and the second portions 504 of a shop vacuum 500. The insert 10 may be attached, secured, and/or fastened to the first portion 502, second portion 504 of the shop vacuum, or both. The attachment may be such that the insert 10 is in direct contact with the first portion 502, the second portion 504, or both. The attachment may be indirect such that additional parts or items may be separating the first portion 502, the second portion 504, or both from the insert 10. An example of such a part may be a gasket, fitting, foam insulation, seal, etc. The insert may be structured as an upper chamber 100. The volume of the collection container 504 may form a lower chamber 102 of the system. The collection container 504 may define the lower chamber 102 while the insert 10, 10′ may define an upper chamber 100.

The insert 10 may be attached or fastened removably such that the insert 10 may be removable and re-insertable, as needed. The insert 10 may be a separate unit which may be placed into different shop vacuums.

It is also contemplated that the insert 10 may become an integral part of a portion of a shop vacuum 500 and be attached non-removably to at least that portion. The removable and/or non-removable attachment may be provided by one or more fasteners. Non-limiting example of fasteners may be bolts, pins, nails, screws, staples, brads, brackets, latches, braces, rivets, hinges, latches, adhesive, Velcro®, straps, foam, or a combination thereof.

Alternatively, or in addition, the insert 10 may be secured via one or more structural features including ridges, nooks, protrusions, projections, holes, gaps, openings, splits, ledges, rims, edges, overhangs, or a combination thereof. The one or more structural features 12 may be located on the first portion 502, the second portion 504, the insert 10, or a combination thereof. In a non-limiting example, the insert 10 may include one or more securing features 12 shaped to fit over an edge or a structural feature of the first and/or second portion 502, 504.

In a non-limiting example of FIG. 2, the insert 10 includes a structural feature 12 shaped as an overhang, which is shaped to securely fit over the top edge of the second portion 504. The overhang may include a ridge 13 arranged to fit over the top edge of the second portion 504, as is shown in FIG. 4.

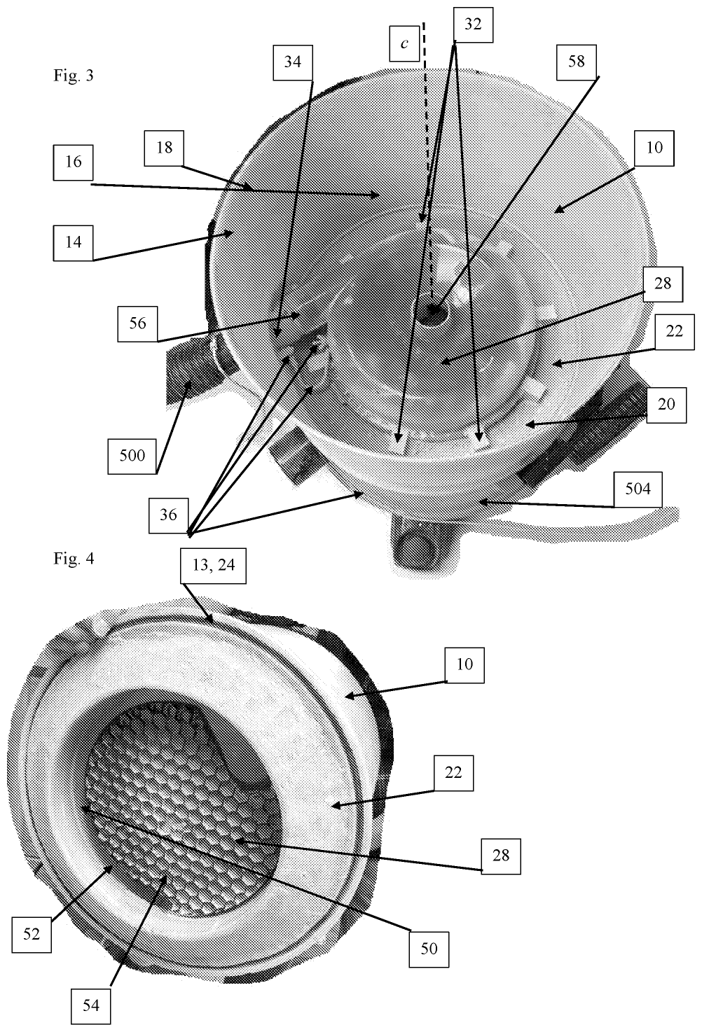

The insert 10 may include one or more parts. The insert 10 may be formed in such a way that the insert 10 includes a housing 14 with an opening 16 on a first or top side 18, as is shown in FIG. 3. The opening 16 may be a full or partial opening. In other words, the opening 16 could be defined by a surface having essentially the same shape as the outer surface of the housing 14 or different shape than the housing 14. The top or first side 18 may include the housing 14, an edge surface 23, which is described below, or both. The top side 18 may be in direct contact with the first portion 502 of the shop vacuum 500. The contact may be partial or full. The contact may encompass full or partial circumference of the first portion 502.

The housing 14 may have various shapes, sizes, and configurations. The housing 14 may be a panel or a wall. The housing 14 may be formed as an integral one piece. The housing 14 may be tubular and include a single round surface. The surface of the housing 14 may be uniform or non-uniform.

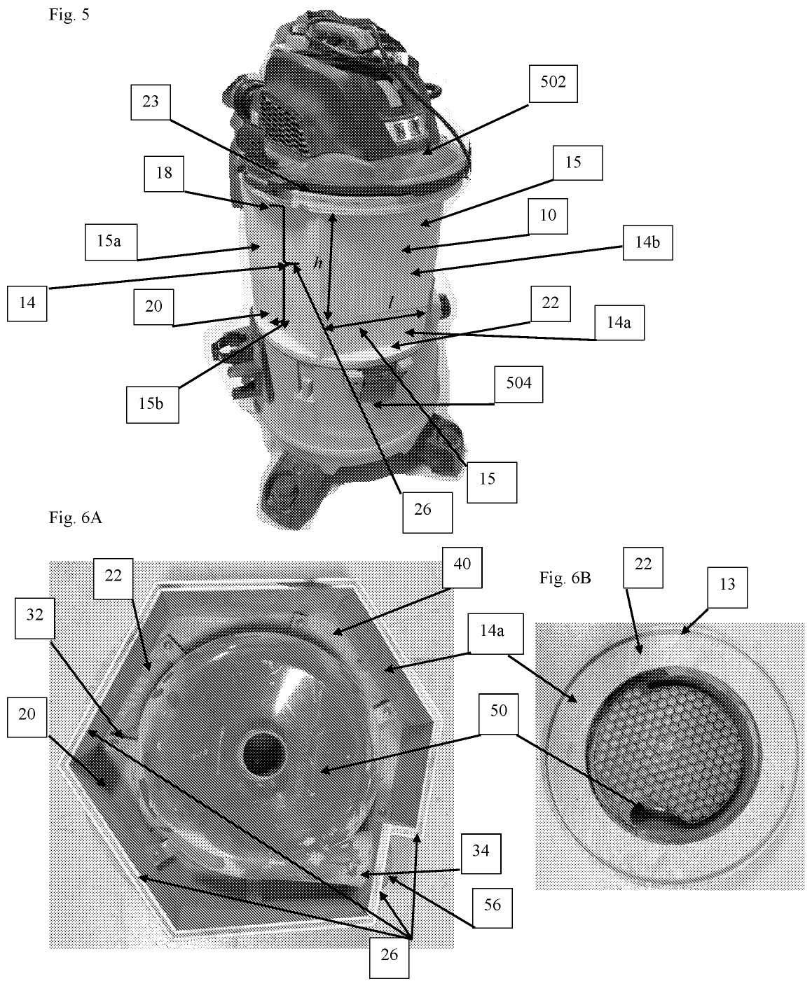

Instead of a single piece, the housing 14 may include a number of portions 15 cut, portioned, assembled, and/or positioned horizontally, vertically, or both. The portions are, for example, shown in FIG. 5 as a top horizontal portion 15a and a bottom horizontal portion 15b, together forming a piece 26. Other portions 15 and piece 26 are contemplated such as 3, 4, 5, 6 or more portions. The portions 15 and pieces 26 may have the same or different size, shape, and/or configuration. The portions 15 and/or pieces 26 may be arranged to connect together to form the housing 14. The connection may be loose, temporary, permanent, secured, free flowing, hardware-free, fastener-free, or a combination thereof. The portions 15 and/or pieces 26 may be aligned or misaligned to give the housing 14 an overall shape mentioned below. A portion 15 and/or piece 26 may be a portion or part that is positioned, aligned, and/or assembled horizontally or vertically with respect to the bottom side 20, top side 18, bottom edge surface 22, top edge surface 23, or a combination thereof.

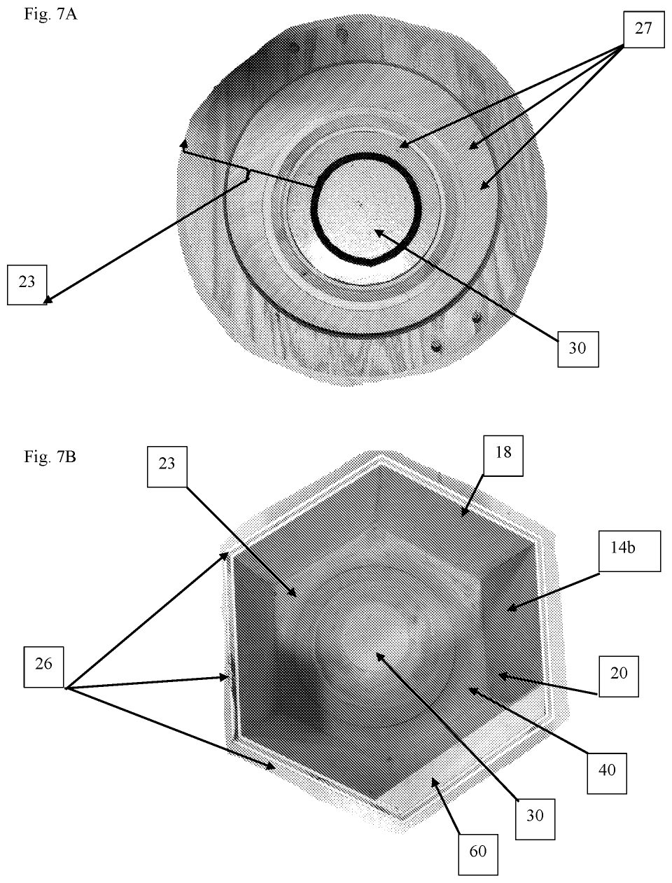

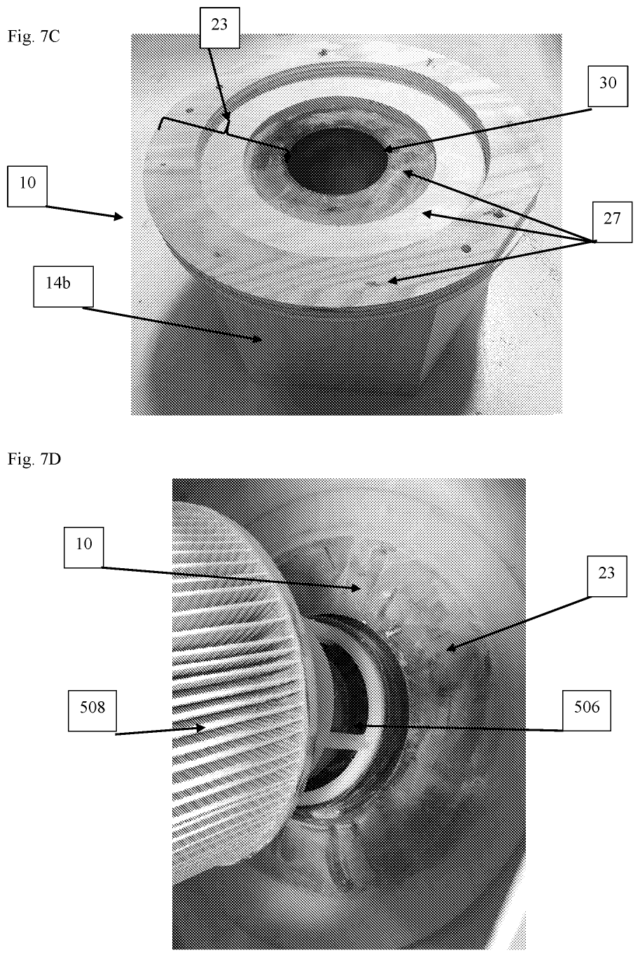

A non-limiting example of the shape of the housing 14 assembled from the portions 15, pieces 26, or both may be a hollow regular or irregular cube, cuboid, cylinder, prism, pentagonal prism, hexagonal prism, heptagonal prism, octagonal prism, nonagonal prism, decagonal prism, or the like. The housing 14 may have a cross-section having a shape of a circle, cylinder, ring, rectangle, square, rhombus, pentagon, hexagon, heptagon, octagon, nonagon, decagon, or the like. The housing 14 may have a uniform or non-uniform thickness throughout. A non-limiting example of the tubular housing 14 is shown in FIGS. 2-4. A non-limiting example of a housing 14 with an irregular octagonal cross-section is shown in FIG. 6A. A non-limiting example of a housing 14 with a regular hexagonal cross-section is shown in FIG. 7B.

The dimensions of the housing 14 may depend on one or more of the following: (a) the type, shape, configuration, and/or dimensions of the dust separator 50, (b) the type, shape, configuration, and/or dimensions of the shop vacuum 500, and (c) the type of particulate matter being removed from the air. For example, the height of the dust separator 50 could influence the height of the insert's housing 14. Likewise, the length of the shop vacuum's motor and filter could also or alternatively influence the height of the insert's housing. The diameter of the first portion 502 and/or the second portion 504 of the shop vacuum 500 could also influence the diameter or width of the insert's housing 14.

The housing 14 may have a bottom housing portion 14a and a top housing portion 14b. A non-limiting example of the bottom housing portion 14a is depicted in FIGS. 6A and 9B. A non-limiting example of the top housing portion 14b is depicted in FIGS. 7B and 7C. The aligned bottom and top housing portions 14a and 14b are shown for example in FIGS. 5 and 11. The alignment may be along the cut line 44 described below.

The insert 10 may further include a second or bottom side 20. The second side 20 is located opposite the first side 18. The second side 20 may form a bottom side of the insert 10 with respect to its placement between the first portion 502 and the second portion 504 of the shop vacuum 500.

The second side 20 may be defined by an edge surface 22. The edge surface 22 may be a surface protruding from a bottom portion of the housing 14, a structural feature 12, or both of the second side 20. The bottom or second side 20 may include the housing 14, the edge surface 22, or both. The edge surface 22 may be flat. The edge surface 22 may be perpendicular to the housing 14 or extend at an angle of less than or more than 90° relative to the housing 14. A non-limiting example of a flat edge surface 22 is shown in FIGS. 5 and 6A, and 6B.

FIG. 6B is a bottom view of the bottom side 20 with a non-limiting example of a dust separator 50 secured to the bottom portion's edge surface 22. The edge surface 22 may also include a ridge for attachment to the bottom portion of the shop vac 500 or an alternative vessel for dust/debris collection. The edge surface 22 may be slanted, angled with respect to the housing 14. A non-limiting example of a slanted edge surface 22 is shown in FIG. 3. The edge surface 22 may be angled at an angle of more than 90° or less than 90° to the plane of the housing 14. The edge surface 22 may be slanted in the direction from the outer edge of the housing 14 towards the center of the bottom side 20. The edge surface 22 may be slanted towards the centerline c of the housing 14, for example shown in FIG. 3. The slant may be gradual.

The edge surface 22 may have universal, uniform, or varying thickness. The variation in thickness may be uniform or nonuniform. For example, the edge surface 22 may have a gradually increasing thickness from the bottom edge 24 of the insert 10 towards the centerline of the housing 14. A non-limiting example of the gradual thickness increase is shown in FIG. 4. Alternatively, the thickness may increase or decrease, gradually, regularly, or irregularly from the center of the bottom side 20 towards the bottom edge 24. Alternatively, the edge surface 22 may have a uniform thickness.

The edge surface 22 may be formed as an integral part of the insert 10, extending from the bottom side 20 of the housing 14. Alternatively, the edge surface 22 may be formed as a separate unit removably or permanently attachable to the housing 14. The edge surface 22 may be formed from one or more pieces or parts 40. The pieces or parts 40 may have uniform or varying shape, size, configuration, and/or dimensions. For example, the edge surface 22 may be formed from one or more circular pieces or rings or pieces having a circular inner edge. The outer edge of the pieces 40 may have a different shape, for example regular, irregular, square, rectangular, pentagonal, hexagonal, heptagonal, octagonal, etc. The individual pieces 40 may have one or more different dimensions from one another. The differing dimensions may be, but are not limited to, thickness, height, width, and diameter. The individual pieces 40 may be centralized or share a common axis. At least one of the individual pieces 40 may be offset and not share the axis of the remaining pieces. The offset may be provided to accommodate one or more features of a dust separator 50.

The second or bottom side 20 may include an opening 28 defined by the edge surface 22. The opening 28 may be a full or partial opening. The opening 28 may have a uniform or varying shape, configuration, and/or dimensions. The opening 28 may be central or offset with respect to the centerline or central axis of the housing 14, the dust separator clean air outlet 58, or a combination thereof.

The first or top side 18, likewise or alternatively, may include an edge surface 23 to which the above description of the edge surface 22 applies. In some embodiments, the edge surface 23 may be omitted such that the first portion 502 of the shop vacuum 500 is fitted onto the insert 10 without the edge surface 23. A non-limiting example of a top side 18 including an edge surface 23 is shown in FIGS. 7A-7D. As can be seen in FIG. 7A, the bottom view of the edge surface 23, the edge surface 23 may include a varying surface including multiple pieces 27 assembled together to form the edge surface 23 contour. The edge surface 23 may include an opening 30. Description of the opening 28 may apply to the opening 30 as well. The opening 30 of the edge surface 23 may correspond to the opening 28 of the edge surface 22. The openings 28 and 30 may or may not align. The opening 30 may be offset with respect to the centerline or central axis of the housing 14, the dust separator clean air outlet 58, or a combination thereof.

FIG. 7B shows the bottom view of the edge surface 23 having an opening 30 and the housing 14. FIG. 7C shows an alternative view; the top view of the edge surface 23 including the varying surface formed by layered pieces 27 and including the opening 30. The housing portion 14b may include a wide flange 60. The wide flange may be aligned with the side of the housing portion 14b having the opening 34.

The multiple pieces 27 may be assembled together in various ways. For example, the pieces 27 may be secured together permanently or temporarily by one or more fasteners named above. The edge surface 23 may form a lid which may be attached to the top or first side 18. The attachment may be temporary or permanent via one or more fasteners named above. The edge surface 23 may form a separation barrier between the first portion 502 of the shop vacuum 500 and the housing 14 of the insert 10. Alternatively, the edge surface 23 may extend or protrude from the first side 18 in such a way that the housing 14 of the insert 10 is in direct contact with the first portion 502 of the shop vacuum 500, the edge surface 23, or both.

If there is an offset in the edge surface 23 of the first or top side 18, the purpose may be to accommodate one or more features of the first portion 502 of the shop vacuum 500 such as a motor, a filter, or both protruding into the space of the insert 10. An example of such offset is shown in FIG. 7C.

Further, as is illustrated in a non-limiting example of an insert in FIGS. 7C and 7D, the varying contour of the edge surface 23 may be shaped to support one or more structural features of the first portion 502 of the shop vacuum 500. The contour of the edge surface 23 may be arranged to ensure a secure and air-tight fit, or relatively air-tight fit, between the first portion 502 of the shop vacuum 500 and the insert 10. FIG. 7D shows the bottom view of the edge surface 23 and the protruding motor 506 and filter 508 of the shop vacuum 500. Even in the absence of the lid formed from one or more pieces 27, an air-tight fit between the top side 18 and the first portion 502 of the shop vacuum 500 is desirable and beneficial for an overall air-cleaning function of the integrated dust separator 50.

At the second or bottom side 20, the insert 10 houses a dust separator 50, as can be seen, for example in FIGS. 3 and 4. The dust separator 50 may be a low-profile dust separator 50, as is shown in FIGS. 3, 4, and 6. The dust separator 50 may be a dust separator described in U.S. Pat. No. 10,857,550, the disclosure of which is hereby incorporated herein. The dust separator may be a different dust separator than the dust separator described in U.S. Pat. No. 10,857,550. The dust separator 50 may be a dust separator having various configurations, sizes, shapes, dimensions, performance levels. The dust separator may be a non-low profile such that the height of the separator is at least three, four, five, six or more times the diameter of the inlet diameter. The dust separator 50 may be nestled, cradled, secured, attached to, and/or situated in the edge surface 22 of the bottom side 20. The dust separator 50 may be arranged within the insert 10 such that there is an air-tight, or relatively air-tight, connection between the edge surface 22 and the dust separator 50. The air-tight connection may be achieved via dimension fitting of the edge surface 22 and the dust separator 50, one or more sealants applied between the edge surface 22 and the dust separator 50, inclusion of one or more gaskets, foam, inserts, the like, or a combination thereof.

The dust separator 50 may be fitted within or over the opening 28. The opening 28 may have such dimensions that allow the dust separator 50 function in an intended manner. For example, the opening 28 may have a diameter dimensioned to expose, leave uncovered the dust separator's particulate matter outlet 52. Such dimensioning enables the dust separator's particulate matter outlet 52 deliver the collected particulate matter into the second portion 504 of the shop vacuum 500 or the collection container 504. A non-limiting example of such arrangement is shown in FIG. 4.

The attachment of the dust separator 50 within the insert 10 may be facilitated by one or more fasteners discussed above. The attachment may be temporary or permanent. An example attachment may be at one or more points via one or more types of fasteners. In a non-limiting example, pegs 32, such as those shown in FIG. 3, may be used to secure the dust separator 50 to the insert 10. Non-limiting types of attachment of the dust separator 50 to the edge surface 22 is shown in FIGS. 3 and 6.

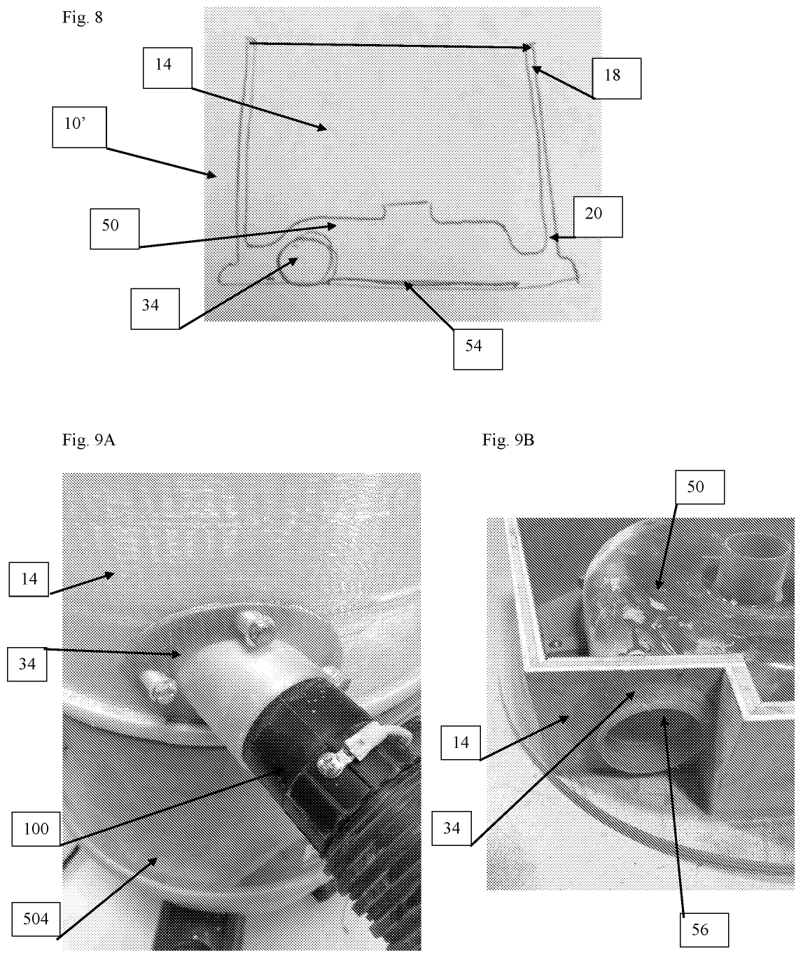

In one or more embodiments, the insert 10 may be a single integral piece, hereby designated as a unitary insert 10′. The integral pieces of the unitary insert 10′ may be produced, for example, by 3D printing, extrusion, injection molding, carving, or by another process. The unitary insert's housing 14, first side 18, second side 20, edge surface 22, and one or more portions of the dust separator 50, as described above, may form one piece, be seamless, be free of fasteners, connections, hardware, or the like. The example part(s) of the dust separator 50 included in this unitary insert 10′ may be the entire dust separator housing except for a separator plate 54 which may be attached separately. In some embodiments, the separator plate 54 of the dust separator 50 may be also included in the unitary insert 10′. A cross-sectional schematic view of the unitary insert 10′ is shown in FIG. 8. The unitary insert 10′ may be configured as a dust separator with a housing extending on the sides, the sides being configured to attach to the first portion 502 and/or the second portion 504 of the shop vacuum 500. One or more types of attachments described herein may be included within the unitary insert 10′, for example at the very top and/or bottom of the insert 10′. In a non-limiting example, the unitary insert 10′ may be cylindrical. A non-limiting example of the insert 10, 10′ with a separator within is shown in FIGS. 22A, 22B, 22D, and 23. In FIGS. 22B and 22D, the insert 10, 10′ also includes a space for one or more filters.

As can be seen, for example, in FIG. 6A, or 8, the insert 10, 10′ may further include an opening 34 for arrangement of the particulate matter laden-air inlet 56 of the dust separator 50. In other words, the opening 34 allows for the material-laden air to enter the insert 10, 10′, the dust separator 50, or both. The opening 34 may be located in the housing 14, the first side 18, the second side 20, or anywhere else in the housing 14. A suitable location for the opening 34 may be in the second or bottom side 20 of the housing 14, aligned with the material inlet 56 of the dust separator 50. The opening 34 may include a frame, extension, neck, one or more fasteners, or another portion structured to facilitate a connection between the dust separator 50, the insert 10, 10′, a hose 500, or a combination thereof.

The hose 500 may connect the insert 10 with a material-generating tool, a vacuum attachment configured for material intake, or the like. In the unitary insert 10′, the opening 34 may be formed as part of the unitary insert 10′ such that there is a seamless transition between the material inlet 56 of the dust separator 50 and remainder of the unitary insert 10′. Non-limiting examples of the opening 34 are also shown in FIGS. 3, 9A, and 9B. In FIG. 9A, the opening 34 is provided with a hardware cover. In FIG. 9B, the opening 34 is fitted over, is in direct contact with the entire circumference of an inlet port 56 of the dust separator 50, which protrudes out of the housing 14 of the insert 10. To provide an air-tight seal between the housing 14 and the dust separator 50, a sealant may be included at one or more connection points.

The opening 34 may be further structured and/or shaped to indicate proper alignment of the insert 10, 10′ to the shop vacuum 500.

A yet another feature of the insert 10 may include a static electricity elimination or reduction device 36. The device 36 may include one or more wires, cables, insulation, fasteners, and so on.

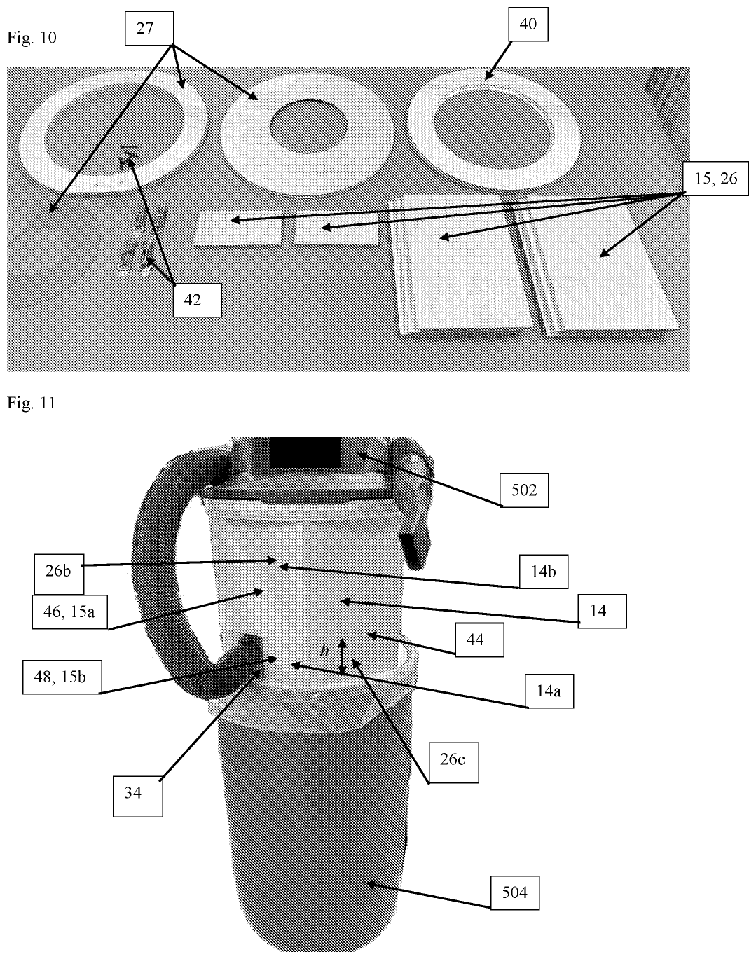

The insert 10 may be packaged or provided to a user as a partially or fully assembled item. Alternatively, the insert may be provided as a kit. The kit may be facilitated as a collection of parts to save storage space and/or provide an opportunity to a crafts person to assemble the insert himself/herself. The kit may include, for example, the disassembled housing 14 having one or more portions 15, pieces 26, one or more pieces 27 to assemble the edge surface 23 of the top side 18 of the insert 10, one or more pieces 40 to assemble the edge surface 22 of the bottom side 20 of the insert 10, one or more fasteners 42 to attach the dust separator to the edge surface 22, a sealant, assembly instructions, optionally a dust separator 50. At least some of the individual pieces of the kit may have to be further adjusted such as cut, polished, glued, etc. to achieve correct assembly of the insert 10. A non-limiting example of a kit may include the individual pieces depicted in FIGS. 5-7D, 9B, and 10.

The kit may include all the pieces precut, with holes predrilled. Alternatively, the kit may include at least some pieces which a user may want to adjust by cutting, drilling, polishing, adjusting, or a combination thereof to form a desired fit, form notches, enable easier assembly, custom adjustments, or the like. For example, the pieces 26 may be cut to form a cut line 44 such that the insert may be easily opened once assembled to gain access to the dust separator 50 housed within the insert 10. The cut line 44 may be made at any height of the pieces 26. A non-limiting example of the cut line 44 location is shown in FIG. 11. The example location of the cut line 44 between pieces 26b and 26c is at a height h. The cut line 44 may include a material with increased roughness, a tape, or another material which may provide enhanced adhesion between housing portions 14a and 14b. The height h may have various values and depend on the specific design. For example, h may be smaller, equal to, or greater than a height of a dust separator 50. The height h may be ½, ⅓, ¼, ⅕, ⅙, 1/7, ⅛, of the height of the insert 10. The cut line 44 may divide the insert into two portions, the upper part 46 and the lower part 48, which may be assembled and/or secured together with or without hardware.

The upper part 46 may include the top side 18, the edge surface 23, one or more pieces 27 to assemble the edge surface 23 of the top side 18, a sealant, one or more pieces 26. The upper part 46 may form a portion 15b.

The lower part 48 may include the bottom side 20, the edge surface 22, the opening 34, one or more pieces 40 to assemble the edge surface 22, one or more fasteners 42, a sealant, one or more pieces 26. The lower part 48 may form a portion 15b.

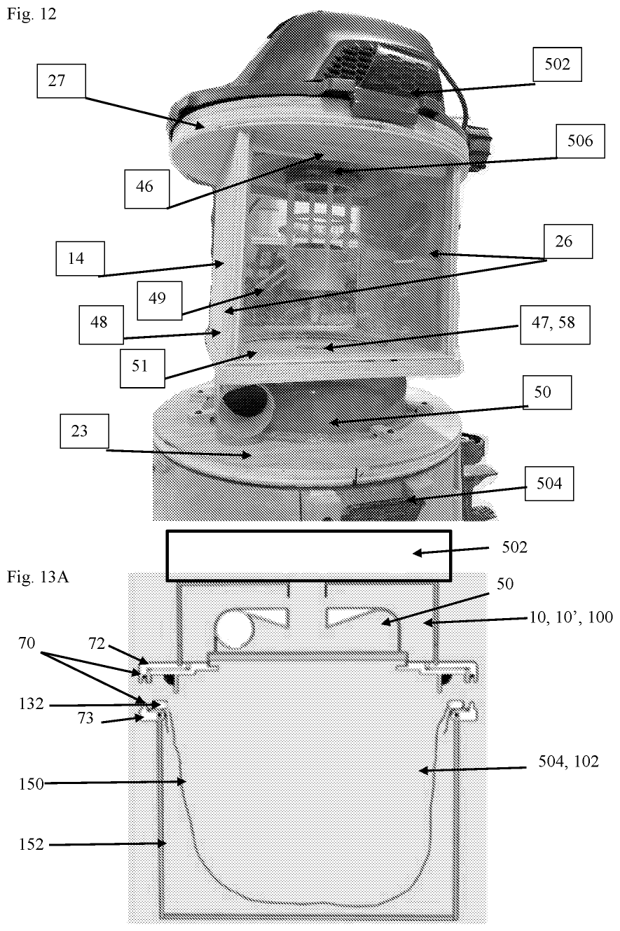

It is also contemplated that the insert 10 may not fully enclose the dust separator 50. For example, one or more portion of the dust separator 50 may be exposed, visible, placed outside of the insert 10. A non-limiting example embodiment is shown in FIG. 12. As can be seen in FIG. 12, the insert 10 includes the top side 18 including assembly pieces 27 accommodating the first portion's 502 motor 506. The insert includes pieces 26 assembled together and forming a chamber into which the motor protrudes. The chamber 49 features an opening 47 configured to accommodate the dust separator's clean air outlet 58. The pieces 26 do not extend to the edge surface 23 the dust separator's bottom portion is secured to. Instead, the pieces 26 are connected to a base 51 which is attached and/or secured to the top portion of the dust separator 50. This embodiment leaves the dust separator's body exposed. The securing may be via one or more fasteners discussed above or be fastener free.

It is further envisioned that the system may include a separator 50 sandwiched between the collection container 504 and the motor portion of the shop vac 502.

The system described herein may further include a bag assembly 70. The bag assembly 70 may form an integral portion of the insert 10′, be part of an insert 10, 10′, or be a separate part which is compatible with the insert 10, 10′. The bag assembly's purpose is to provide an easy, clean way of dust and debris disposal from the system. The bag assembly enables collection and removal of the dust and debris collected within the collection container 504.

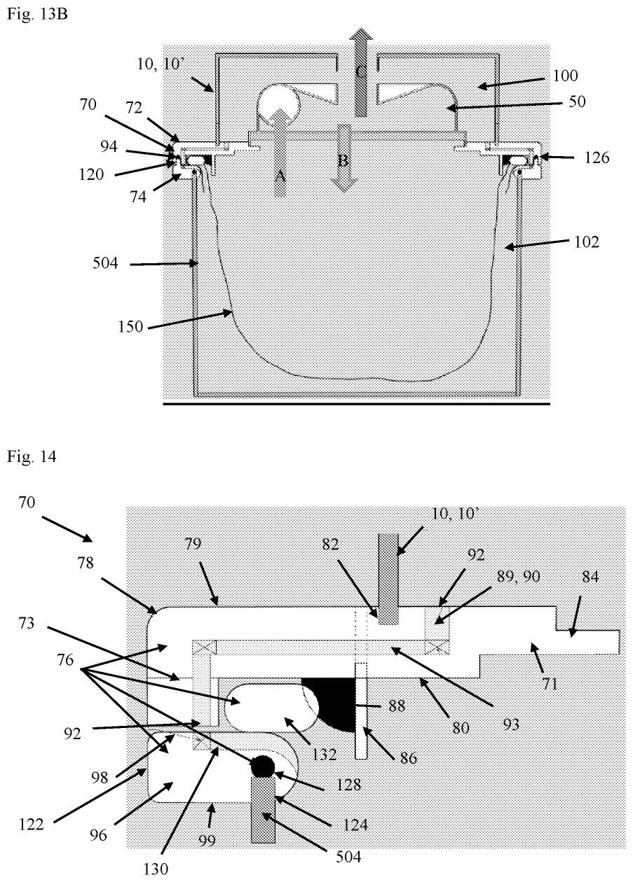

A schematic depiction of the bag assembly 70 is shown in FIGS. 13A-19, 23 and 24. FIGS. 13A, 13B show a non-limiting example of the system disclosed herein including the collection container 504, the bag assembly 70, and an insert 10, 10′. While not depicted in FIG. 13B, the insert 10, 10′ may be connected to a motor portion 502 of the shop vac 500. The insert 10, 10′ includes a separator 50. The insert 10, 10′ may also include a secondary filter 300, as is depicted in FIG. 23. While a low-profile separator 50 is depicted, any separator is contemplated, for example a separator depicted in FIG. 22C. The mechanical, physical, and/or fluid connection between the collection container 504 and the insert 10, 10′/separator 50 is facilitated via the bag assembly 70.

FIG. 13A shows an open position of the bag assembly/system and FIG. 13B shows a closed position of the bag assembly/system. As can be seen in FIG. 13A, the bag assembly 70 may include a top subassembly 72 and a bottom subassembly 73. The top and bottom subassemblies 72, 73 cooperate, are compatible, are structured to form a seal in the closed position, eliminate any leaks between the insert 10, 10′ and the collection container 504, or a combination thereof. The top subassembly 72 may be an integral part of the insert 10, 10′. The bottom subassembly 73 may be an integral part of the collection container 504. Alternatively, the bottom and top subassemblies 72, 73 may be removable, temporary parts of the system described herein. Separating the bag assembly into the top and bottom subassemblies allows a user to easily lift the insert 10, 10′ with the top subassembly 72 off of the collection container 504, remove a collection bag, install a bag, or a combination thereof.

The bag assembly 70 and its subassemblies 72, 73 may include a plurality of components which are shown in greater detail in cross-sectional views of FIGS. 14-16. The shown assemblies are non-limiting examples only and other shapes, sizes, and configurations of parts are contemplated.

Depending on the shape of the insert 10, 10′ and the collection container 504, the bag assembly 70 may include one or more plates, circles, rings, and/or other components 76 structured to be in contact with a side and/or bottom portion of the insert, the side or top portion of the collection container, or both. At least some or all of the components 76 may be symmetrical. At least some or all of the components 76 may be concentric circles or rings. At least some of the components 76 may include one or more notches, protrusions, indentations, platforms, holes, through-holes, channels, cavities, walls, or a combination thereof.

One of the components 76 may be a first plate 78. The first plate 78 may be a ring. The first plate 78 may be a relatively flat component with a level surface. The first plate may include a first surface 79 which may be relatively flat, for example form a top flat surface, and a second surface 80 which may be flat, uneven, raised, and/or structured. The first and/or second surfaces 79, 80 may encompass a body having one or more notches, protrusions, indentations, platforms, holes, through-holes, channels, cavities, walls, or a combination thereof. The general body of the first plate 78 may include one or more curvatures and/or right-angle transitions between surfaces.

The first plate 78 may include one or more notches, indentations, or raised portions 82 to accommodate one or more portions of the insert 10, 10′, for example a side of the insert.

The first plate 78 may include a platform, one or more notches, indentations, and/or raised portions 84 to accommodate, support, or be in contact with a separator 50. The platform 84 may be located at a proximal end 71 of the first plate 78 with respect to the placement of the separator 50.

The first plate 78 may include a wall 86 extending from the second surface 80. The wall 86 may be perpendicular to the second surface 80. Alternatively, the wall 86 may be an extension of the second surface 80 towards the bottom subassembly 73 in a variety of angles including an acute or obtuse angle. Attached to the wall 86 and/or the second surface 80 may be a seal 88. The seal 88 may be a sealing ring. The seal 88 may be rigid or collapsible. In a non-limiting example, the seal 88 may be a collapsible foam seal. The wall's length may be the same or different as the length of the seal 88. For example, the wall 86 may be longer or shorter than the length of the seal 88. In one or more embodiments, the wall's length is smaller or equal to the length of the seal 88. In one or more embodiments, the seal 88 may be attached to the second surface 80 only. The seal 88 may be suspended within a notch in the second surface 80. The seal may be flush with the second surface 80.

The first plate 78 may include a channel, system of channels, pressure equalization system 89, or a combination thereof. The pressure equalization system 89 is an internal system housed within the bag assembly 70 components such as the top subassembly 72, the bottom subassembly 73, or both. The top and bottom subassemblies 72, 73 may be arranged to be cooperating, separable, repeatedly separable, attachable to one another, detachable from one another, or a combination thereof.

The pressure equalization system 89 may include a channel or channel system 90. The channel or channel system 90 may include one or more tunnels, canals, conduits, chambers, ducts, passages, and/or tubes. The channel or channel system 90 may be internal to the body of the bag assembly 70, the first plate 78, the second plate 96, or both. The channel or channel system 90 may form a labyrinth arranged to conduct a fluid between the upper chamber 100 and lower chamber 102 of the system disclosed herein.

The channel system 90 may lead from the first surface 79 via the body of the first plate 78 to the second surface 80. The channel system 90 may have two or more openings 92. The number of openings 92 may be 1, 2, 3, 4, 5, 6, 7, 8, 9, 10, or more. The openings 92 may be fluid inlets, outlets, or serve as both.

The channel system 90 may have a vertical passage leading from each or at least one opening 92 into a main passage 93. The main passage 93 may be an exclusively inner structure within the first plate 78. The main passage 93 may be a horizontal passage or part of the channel system 90. The pressure equalization system 89 may include more than one main passage 93, for example 1, 2, 3, 4, 5, 6, 7, 8, 9, 10, or more. The main passages 93 may be the same or different, having the same or different, shape, configuration, dimensions, etc.

The channel system 90 may have one or more openings 92 located between the notch 82 and the platform 84. The channel system 90 may have an opening 92 located in the portion of the first plate 78 which is located within the insert when the system is assembled. The opening 92 is thus located in an area within the insert which allows air exiting the separator to enter the channel 90. The opening 92 may be thus located within the upper chamber 100 of the system. The opening 92 may be located at the proximal end 71 or adjacent to the proximal end 71 of the first plate 78. An opening 92 may be located at the distal end 73 of the first plate 78. A main passage 93 may thus traverse the entire body of the first plate 78, originating with a vertical passage extending from the first opening 92 at the proximal end 71 and terminating with a vertical passage terminating in the second opening 92 at the distal end 73.

The pressure equalization system 89 may be free of any openings besides the openings terminating into the lower and upper chambers 100, 102. This ensures exchange of the air between the chambers. The upper and side surfaces of the first plate's distal end may thus be free of any openings. Likewise, the lower and side surfaces of the second plate's distal end may be free of any openings.

The channel system 90 may have one or more curvatures. In a non-limiting example, the channel system 90 may include two curvatures between the two openings 92 described herein. A different number of curvatures is contemplated.

The channel system 90 may have the same or different, regular or irregular internal dimensions throughout its length. The channel system 90 may extend along the entire perimeter or circumference of the first plate 78 such that the entire body of the first plate 78 includes the channel system 90. Alternatively, the channel system 90 may form a cavity extending via only a portion of the body of the first plate 78. The channel system 90 may be structured to be in fluid communication with the upper chamber 100 and the lower chamber 102 such that air can flow between the upper chamber 100 and the lower chamber 102.

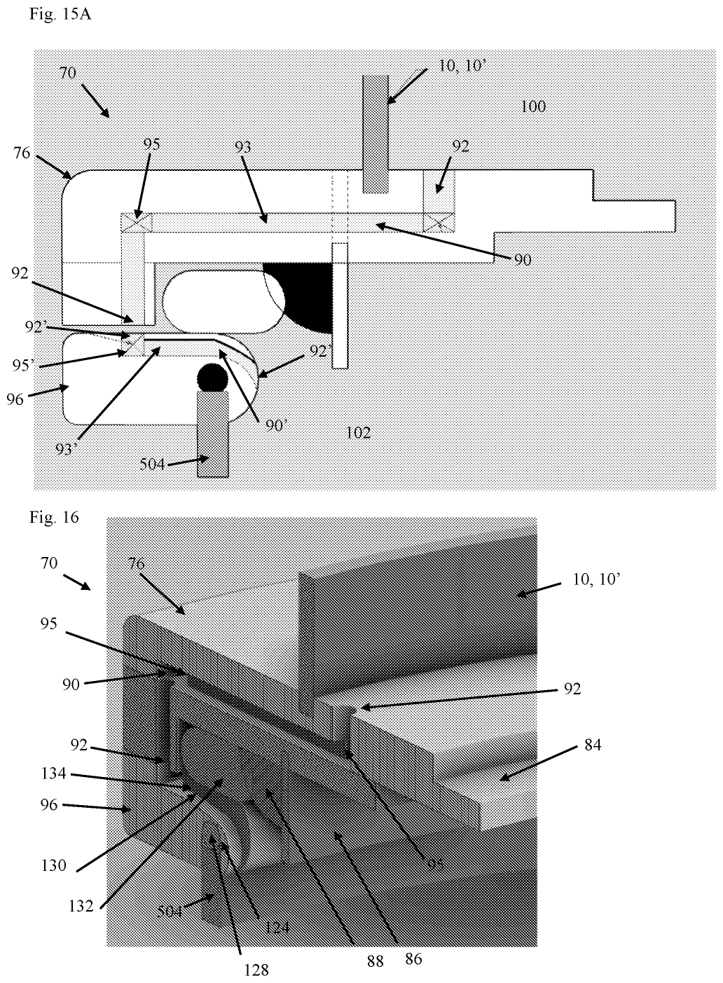

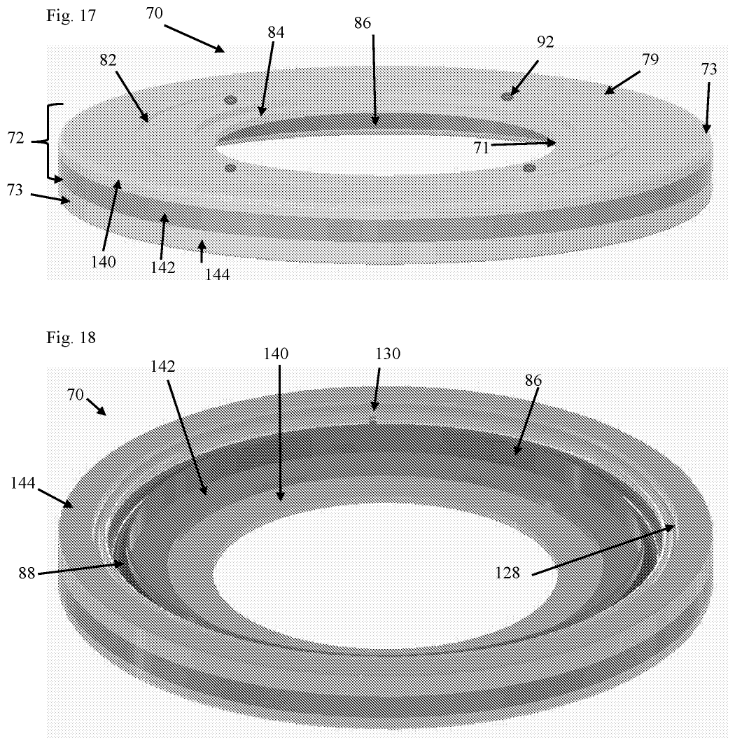

It is also contemplated that the channel system 90 may include a main passage 93 and one or more branches, extending from the main passage 93. For example, the main passage 93 may extend perpendicularly to the periphery of the first plate 78 with one or more branches extending from the main passage 93 parallel to the periphery of the first plate 78. A non-limiting example of the first plate 78 having four openings 92 extending into vertical passages which transition into the main passage 93 is shown in FIGS. 16 and 17.

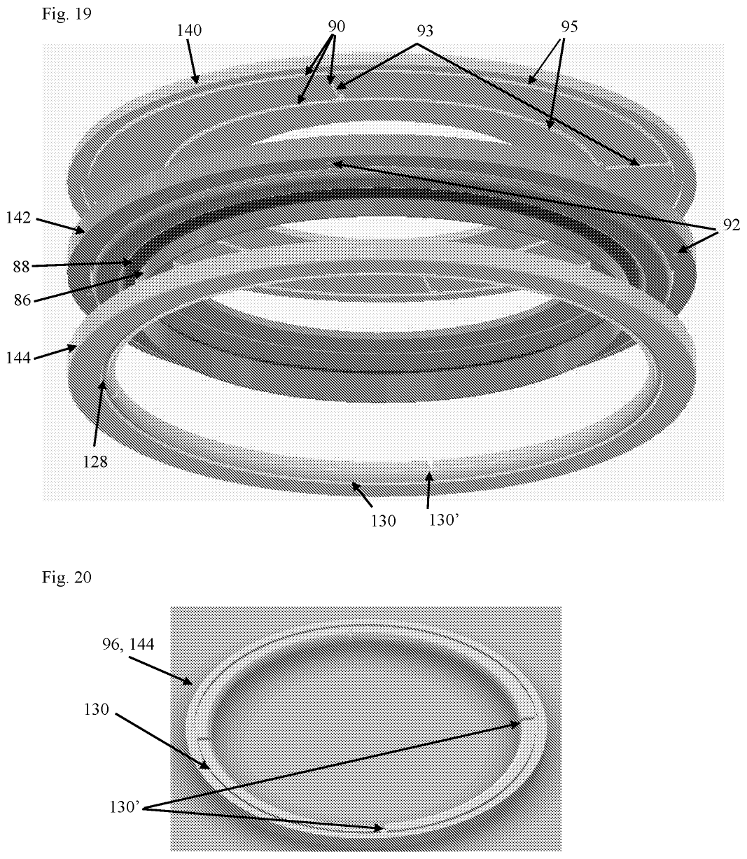

A main passage 93 may include additional conduits, channel, branches, labyrinth of channels 95 which may be interconnected. The channel system 90 may thus have one or more branches 95, extending from the main passage 93. FIG. 16 shows a non-limiting example of the main passage 93 branching into additional channels 95. In a non-limiting example, the main passage 93 may extend perpendicularly to the periphery of the first plate 78 with one or more branches 95 extending from the main passage 93 parallel to the periphery of the first plate 78. A non-limiting example of the first plate 78 having four openings 92 extending into vertical passages towards the main passage 93 is shown in FIG. 17. FIG. 19 shows a non-limiting example of the main passages 93 extending to the branches 95 in a symmetrical manner. Asymmetrical arrangement is also contemplated. The system of the main passages, branches, and channels may form an internal labyrinth within the body of the first plate 78, the second plate 96, the bag assembly 70, or a combination thereof.

The main passages 93 may connect to the branches concentric 95 to the overall shape of the collection container 504. The concentric branches 95 may be structured to position the top subassembly 72 onto the bottom subassembly 73 at various angles as long as the top and bottom subassemblies 72, 73 are nestled in such way that the seals make contact.

The channel system 90 may be formed within a unitary piece of the first plate 78. Alternatively, the first plate 78 may be assembled from one or more components such as concentric rings. The channel system 90 in such an assembly may be formed by layering of the one or more rings on top of each other. A non-limiting example of such an embodiment is shown in FIGS. 16-21.

The distal end 73 of the first plate 78 may further include one or more notches, protrusions, and/or indentations 94 structured to cooperate with a mating piece of the bottom subassembly 72. An example of such structure 94 is shown in FIGS. 13A and 13B. Alternative attachment structures between the top subassembly 72 and the bottom subassembly 73, the first plate 78 and the second plate 96, or both, such as roughened surface, adhesive, fasteners, latches are contemplated. Alternatively still, the distal end 73 may be free of additional structures such that the surface may be flat. Further still, a seal may 126 be provided between the second surface 80 and a top surface 98 of the bottom subassembly 73.

One of the components 76 may be a second plate 96. The second plate 96 may include a first or top surface 98 and a second or bottom surface 99. Either surface 98, 99 may include one of more notches, indentations, protrusions, platforms, and/or the like. For example, the top surface 98 may include a securing structure 120 corresponding to the shape of a structure 94 of the first plate 78 such that the securing structure 120 and the structure 94 cooperate, fit within one another, provide a seal, or a combination thereof. The structure 120 may be a notch, protrusion, indentation, etc. The securing structure 120 may be located on the top surface 98. The structure 120 may be located in a central portion of the top surface 98, at the distal end 122 of the second plate 96, or both.

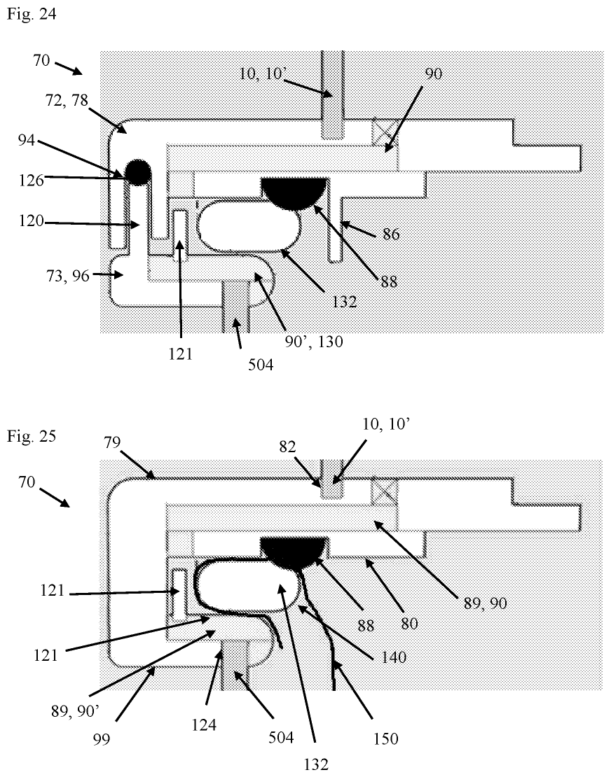

The top surface 98 may include a wall 121. The wall 121 may protrude from the top surface 98 towards the first plate 78. The wall 121 may be located in a central portion of the top surface 98, adjacent, or immediately adjacent to the securing structure 120, the bottom surface of the first plate 78 at its distal end, or a combination thereof. The wall 121 may have such dimensions that the wall 121 does not prevent alignment of the air passageway and any securing structures of the assembly 70. A non-limiting example of the wall 121 is shown in FIG. 24.

As was stated above, the assembly may include a seal such as an O-ring, foam seal, adhesive, etc. 126 to form an airtight seal between the top subassembly, bottom subassembly, the system.

The second plate 96 may include a notch 124 structured to accommodate a portion of the collection container 504. The portion may be the top portion or rim of the collection container 504. The notch may include a seal 128 such as an O-ring or foam to secure an airtight seal between the assembly 70, the bottom subassembly 73, and the collection container 504 within the system.

The second plate 96 may include a channel system 90′ having two or more openings 92′, one or more main passages 93′, and/or one or more branches 95′. The channel system 90′ may correspond to the channel system 90 of the top subassembly 72 and the description of the channel system 90 and its portions may thus apply to the channel system 90′. A non-limiting example of the channel system 90′ and its components is shown in FIG. 15. The channel systems 90, 90′ may have the same dimensions, shape, configuration. Alternatively, the channel systems 90, 90′ may differ in at least one dimension, shape, configuration, or a combination thereof.

The channel systems 90 and 90′ align such that when the top and bottom subassemblies are placed in contact, the channel system 90 continues into the channel system 90′ via alignment of the openings 92, 92′ or otherwise. A fluid, or the air, may thus flow from the upper chamber 100 to the channel 90 via the first opening 92 of the first plate 78, through the channel 90 and to the channel 90′ via the second opening 92 of the first plate 78 and the first opening 92′ of the second plate 96, through the channel 90′ and into the lower chamber 102 via the second opening 92′ of the second plate 96. The reverse airflow from the lower chamber 102 to the upper chamber 100 proceeds via the same route in reverse order.

In an alternative embodiment, shown in FIG. 14, the second plate 96 may include a groove, cut, gap, notch, indentation 130. The groove 130 may be formed in the top surface 98 of the second plate 96, forming a suspended, lower, canyon-like area. The groove 130 may align with the second opening 92 of the first plate 78 when the top and bottom subassemblies 72, 73 are aligned. The groove 130 may lead the air from the upper chamber 100 into the lower chamber 102. The second plate 96 may include a groove 130 along the periphery or circumference of the second plate 96. The second plate 96 may include additional grooves 130′ parallel to the channel 90, 90′, groove(s) 130, or a combination thereof. A non-limiting example of the grooves 130, 130′ is shown in FIG. 20. The groove 130 may extend to the securing structure 120, as is shown for example in FIG. 24.

The one or more components 76 may include a bag retaining component 132. The bag retaining component 132 may be a ring, circular component, or a component structured to secure a collection bag 150 within the assembly 70. The bag retaining component 132 may be sized to fit between the seal 88, the wall 86, the second surface 80 of the first plate 78, the distal end 73 of the first plate 78, the top surface 98 of the second plate 96, the holder 134, or a combination of one or more of these components. The bag retaining component 132 may be secured, inserted, reinserted, reinsertable between the distal end 73 of the first plate 78 and the seal 88 or the wall 86. The bag retaining component 132 may fit relatively loosely within the described space such that the resistance during removal of the bag is minimized. Alternatively, the second plate 96 may include a bag retaining component's holder 134. A non-limiting example of the holder 134 is shown in a cross-sectional view of FIG. 16. The holder 134 may be a raised portion of the second plate 96 onto which the bag retaining component 132 may be placed. The holder 134 may be the top surface of the second plate 96. The bag retaining component 132 may be part of the top subassembly 72, the bottom subassembly 73, or a separate portion of the bag assembly 70.

The collection bag 150 may be a generic plastic bag 150 such as a disposable plastic collection bag. The bag 150 may be made from other materials such as paper, petroleum-based resins such as polyethylene, biodegradable materials, recyclable materials, etc.

A non-limiting example of the bag assembly 70 is shown in FIGS. 16-21. FIG. 16 shows a perspective cross-sectional view of the bag assembly 70 including the top subassembly 72 with an attached insert 10, 10′, the bottom subassembly 73 with the collection container 504 attached, and the bag retaining component 132.

FIG. 17 shows a top perspective view of the assembly 70 with the top subassembly 72 being formed by a plurality of rings, specifically a first ring 140 and a second ring 142. The first and second rings may be fitted together to form the top subassembly 72 with the internal pressure equalization system 89. A third ring 144 forms the bottom subassembly 73. The bottom perspective view of the same assembly 70 is shown in FIG. 18. FIG. 18 further shows the seal 88, seal 128, and grooves 130′. An exploded perspective bottom view of the same assembly 70 is shown in FIG. 19. The channel system 90 with the main passages 93 and branches 95 is shown in the first ring 140.

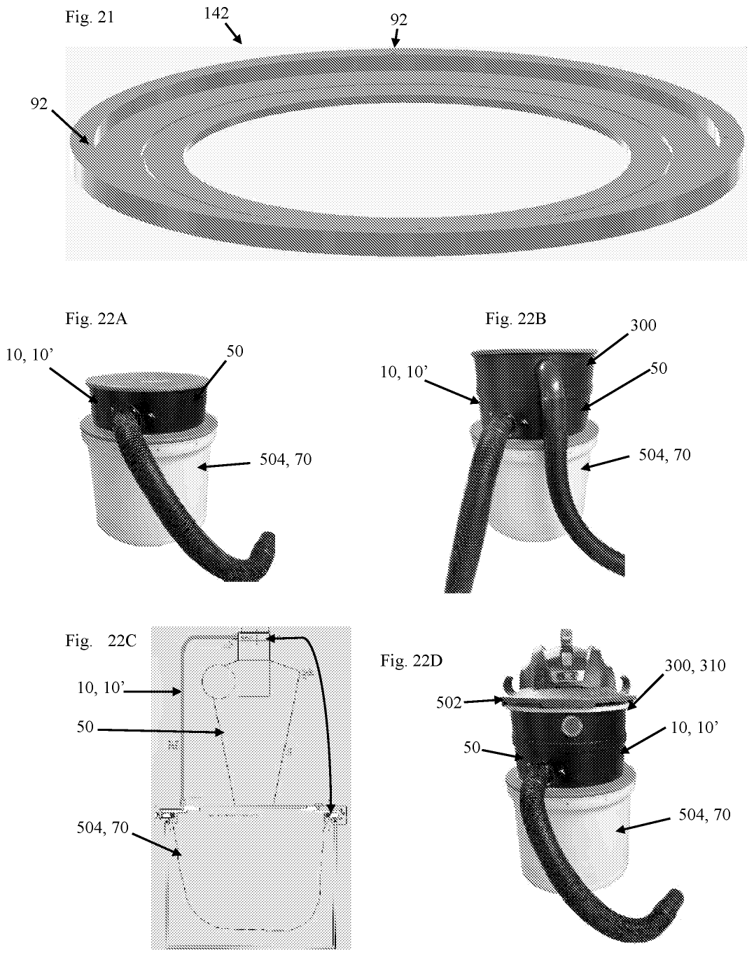

FIG. 20 shows a detailed top perspective view of the bottom subassembly 73 third ring 144 with the grooves 130 and 130′. FIG. 21 shows a bottom perspective view of the second ring 142 with the openings 92. FIG. 21 further shows the surface which is in contact with the wall 86 and the seal 88.

The first plate 78, the top subassembly 72, or both may be free of one or more structures such as structures 82, 84, 86, and/or 94. The second plate 96, the bottom subassembly 73 may be free of one or more structures such as structures 120, 121, seals 126, 128, or a combination thereof.

In one or more embodiments, the bag assembly includes the body 70 as a unitary piece such that the top subassembly and the bottom subassembly are permanently connected or formed as one piece. A non-limiting example of the unitary bag assembly is shown in FIG. 25. Unitary may mean formed as one piece, free of seams, fasteners, or attachments between its portions. The top surface 79 of the one piece bag assembly 70 may include a feature such as structure 82 to be attached to the insert 10, 10′. Likewise, the bottom surface 99 of the bag assembly 70 may include a feature such as structure 124 to be attached to the collection container 504. The pressure equalization system 89 is internal to the body of the unitary piece. The bag retaining component 132 may be insertable within, attachable to, compatible with a nook, cavity, opening 140 formed between the bottom surface 80, top surface 98, structure 121, or a combination thereof. The structure 121 may prevent the bag retaining component 132 from blocking air flow within the channel 90, 90′. The bag assembly 70 may be removable from the insert 10, 10′, collection container 504, or both. An advantage of the unitary piece may include guaranteed alignment of the pressure equalization system channels and ease of manufacturing. In contrast, a multi-part assembly may provide the advantage of easy installation and removal of the collection bag. The unitary piece may be also formed as part of the unitary insert 10′ such that the piece includes the separator body, separator plate, sides of the insert, or the like.

To assemble the herein-disclosed system having subassemblies 72, 73, the insert 10, 10′ may be fitted into or onto the top subassembly 72. A bag 150 may be installed onto the bag retaining component 132 and placed within the collection container 504. The bag 150 may rest loosely within the container 504. The bag retaining component 132 may be rested onto the bottom subassembly's top surface 98 or the bag retaining component's holder 134. A non-limiting example view of the open system is shown in FIG. 13A and the closed system in FIG. 13B.

To form the closed system, the top subassembly 72 may be brought down onto the bottom subassembly 73, or vice versa. As the top subassembly 72 encounters the bottom subassembly 73, the following may happen: (a) any mating or corresponding components of the assemblies may cooperate and form a positioning guide and a close fit between the subassemblies, further made airtight by the presence of the one or more seals 88, 126, 128, (b) the channel system 90, channel system 90′, grooves 130, and/or grooves 130′ become aligned, forming an air passageway from the lower chamber 102 to the upper chamber 100 and vice versa, (c) the bag retaining component 132 with an attached bag 150 comes in contact with the seal 88 providing such compression of the bag 150 that particulate material, dust, debris, etc. collected within the lower chamber 102 is prevented from moving into the space between the bag 150 and the collection container wall 152.

To assemble the herein-disclosed system having a unitary bag assembly 70, the unitary piece may be attached to the insert 10, 10′, the collection container 504, or both. Prior to this attachment, a bag may be installed around, into, or onto the bag retaining component 132 which may be inserted within the assembly 70 as described above.

As the system disclosed herein is activated or turned on, a vacuum evacuates air from the entire system, thereby causing incoming air laden with dust and debris to be drawn into the separator 50 from an external hose connection, indicated schematically by an arrow A in FIG. 13B. Separated dust and debris fall into the collection bag 150 installed within the collection container 504, schematically indicated by arrow B. At the same time, the mostly clean air exits the separator and moves to the vacuum head portion 502 placed above the insert 10, 10′, schematically indicated by arrow C. In the closed, activated system, atmospheric pressure is outside of the assembly, low-pressure clean air is in the upper chamber 100, and low-pressure air with collected material is in the lower chamber 102. The system thus has a low pressure area common to the entire system in the upper chamber and the lower chamber. At the same time, pressure is equalized between the separator 50 and the collection container 504 by the pressure equalization system 89. The air passageway formed by the channel systems 90, 90′ enables movement of air from the lower chamber 102 to the upper chamber 100. Specifically, the passageway is a pathway for air trapped between the bag 150 and the collection container outer wall 152 which allows the bag 150 to fully deploy and maximize its use. As the bag 150 fills with the dust and debris, the bag 150 may fully expand and conform to the shape of the collection container 504, forcing out any air that may have stayed in the space between the bag 150 and the container wall 152.

The system's advantages include elimination of numerous connection hoses resulting in a space-saving, compact apparatus, time-saving equipment utilizing a collection bag free of leaks within the system and having a capability to maximize capacity of the collection bag, ease of separation of the bag assembly for emptying by having a top subassembly and the bottom subassembly, excellent pre-separation ahead of the primary system filter resulting in prolonged filter lifetime, use of generic low-cost collection bags for disposal of dust and debris, elimination of any external pressure equalization tube to allow full deployment of the collection bag within the container. The system may be a compact, vertical, versatile, stackable system of individual removable components described herein.

The bag assembly 70 may be applicable to any system including low pressure area in two or more chambers. Non-limiting example systems are shown in FIGS. 22A-D. The bag assembly 70 may be also utilized in other systems such as in a system combining a cyclonic separator, either a low-profile version such as one depicted in a non-limiting example of FIG. 22A or a conventional separator such as the one depicted in FIG. 22C. Separators of other designs, configurations, shapes, and sizes are also contemplated.

Alternatively, the bag assembly 70 may be used in a system having a collection container 504, bag assembly 70, a low-profile cyclonic separator within a unitary insert 10′, and a secondary foam filter 300. A non-limiting example of such system is shown in FIG. 22B.

Further still, the bag assembly 70 may be used in a system having a collection container 504, bag assembly 70, a low-profile cyclonic separator within a unitary insert 10′, one or more filters such as a secondary foam filter 300, a pleated filter such as HEPA filter 310, and a first portion 502 of the shop vacuum 500 with the vacuum head. A non-limiting example of such system is shown in FIG. 22D.

In a non-limiting embodiment of FIG. 23, a cross-section of a system is shown. The system may include the collection container 504, the bag assembly 70, and the insert 10, 10′ housing a separator 50 in combination with a secondary filter 300. The secondary filter 300 may be arranged above the separator 50 within a platform 302. The insert 10, 10′ may include one or more additional openings 304 to house an attachment hose, serve as an inlet, outlet, or both. The insert may feature a top or lid 306. The lid may be replaceable with the first or motor portion 502 of a shop vac 500. The detailed view of the bag assembly 70 of the system of FIG. 23 is shown in FIG. 24.

The insert 10, 10′ may be made from one or more materials. For example, one of more portions of the insert may be made from one or more types of wood. All the portions may be made from the same type of wood. Alternatively, at least some of the portions may be made from a different type of wood than at least one other portion. The wood may be smooth, polished, and/or sanded. At least some of the portions, parts, or pieces may be made from solid wood. At least some of the portions, parts, or portions may be made from particle board, chip board, or another type of an engineered wood board including wood chips, sawdust, wood shavings, or another wood material, and a binder. Other natural, biodegradable materials are contemplated.

At least some of the portions may be made from more than one layer of the same or different material, the layers being attached to one another, for example with a binder to form an individual portion of the insert.

The insert may be made from a resin, polymer, synthetic and/or natural fibers, composite material, rubber, rubber-like material, metal, ceramic, the like, or a combination thereof. The plastic may be thermoplastic, thermoset, or both. The insert may be made from the same material as the separator or the body of the separator.

The insert may ma made from materials having different flexibility or rigidity. All the materials or pieces 15, 26, 22, 23, 27, 40, may be rigid having Young's modulus x. Alternatively, at least some of the pieces may have rigidity having Young's modulus y, where y is different than x. y may be greater or smaller than x. In other words, at least some of the portions of the insert may exhibit different values of rigidity.

The insert may include at least one part, piece, or portion made from glass, plexiglass, transparent, translucent material, see-through material, and/or the like, as is for example shown in FIG. 12. The see-through material may be included to provide an option of a visual check of the dust separator function, the shop vac's motor, filter, or the like.

In one or more embodiments, a method of assembling the insert 10 is disclosed herein. The method may include a step of preparing, measuring, cutting, polishing, or otherwise readying one or more pieces, parts, or portions of the assembly kit. The method may include cutting pieces 15, 26 to predetermined dimensions and shapes. The method may include aligning one or more pieces 15, 26, 27, 40. The aligning may include using one or more dowel pins to locate and/or join individual pieces or components of the kit together. The aligning may be provided with respect to one or more pieces 15, 26, 27, or 40. The aligning may include offsetting one or more pieces, such as pieces 27 with respect to the centerline of the housing 14 or insert 10.

The method may include securing one or more pieces together temporarily, for example via tape, clamp(s), dowel pin(s), or another type of fastener. The method may include securing one or more pieces together permanently. The method may include using clamps or other fasteners, which are to be removed later, to temporarily secure the assembled pieces together until a predetermined time. The predetermined time may be a time in which an adhesive cures.

The method may include cutting or otherwise separating the assembled housing 14 at a height h into the upper part 46 and the lower part 48, as described above. The method may include polishing the cutline at the height h. Alternatively, the method may include cutting pieces 15, 26 at a dimension h and then assembling pieces 15, 26 of the upper part 46 and the lower part 48 separately.

The method may include assembling the edge surface 23 of the top side 18 from one or more pieces 27. The method may include assembling the edge surface 22 of the bottom side 20 from one or more pieces 40.

The method may include attaching the top edge surface 23 to the housing 14 or the upper part 46 of the insert 10, attaching the bottom edge surface 22 to the housing 14 or the lower part 48, or both.

The method may include forming an opening 34 by cutting, aligning pieces, or both. The method may include placing a dust separator into the edge surface 22. The method may include securing a dust separator 50 within the insert 10 permanently or temporarily. The securing may include removably attaching the dust separator 50 within the insert 10. The securing may include placing one or more pegs or fasteners into the edge surface 22 and along the periphery of the dust separator 50. The method may further include assembling the upper part 46 and the lower part 48 of the housing 14. The assembling may include aligning the upper part 46 and the lower part 48. The aligning may be provided in such a way that at least one upper portion 15a's bottom edge aligns with a lower portion 15b's top edge.

The method may further include placing/securing/attaching the assembled insert 10, housing 14, lower part 48 onto the second portion 504 of the shop vac 500, placing/securing/attaching the upper part 46 onto the lower part 48, and/or placing/securing/attaching the first portion 502 of the shop vac 500 onto the inset 10, housing 14, upper part 46, the top side 18, and/or the edge surface 23. The method may further include placing/securing/attaching the dust separator 50 into the insert 10 before or after the insert 10 is installed within the shop vac 500.

The method may include attaching a hose to the insert's particulate matter laden-air inlet 56 via an opening 34. The method may include activating the shop vac 500. The method may include collecting debris in the second portion 504.

In a non-limiting example, the method may include one or more of the following steps: removing hardware such as clips or hose clips from the shop vacuum's 500 first portion 502 power unit; forming one or more holes in the posts that contained the hardware; positioning the first portion over top ring 27 by aligning the posts with the holes of the top ring 27; replacing the initial and removed hardware with alternative hardware such as screws; installing a filter over a pleated or another filter of the shop vacuum; aligning a dust separator 50 with the bottom housing portion 14a including the opening 34; securing the dust separator 50 within the bottom housing portion 14a, for example with latches; aligning the top housing portion 14b with the bottom housing portion 14a such that a side having a wide flange 60 of the top housing portion 14b is located above the opening 34; securing the bottom and top housing portions together, for example by a fastener; placing the assembled housing with the first portion 502 or the shop vacuum 500 onto the second portion or the collection bucket 504 of the shop vacuum 500. The method may also include removing a top portion of the air outlet 58 of the dust separator such that the outlet 58 does not feature a wall, or only features a shorter and/or partial wall, and is flush with the top surface of the dust separator 50.

The method may include installing a bag assembly 70 within the system including an insert 10, 10′, collection container 504, and optionally the first portion of the shop vacuum 502 including the vacuum head. The installation may include attaching a collection bag 150 to a bag retaining component 132. The attaching may be by wrapping, folding, inserting, or the like. The method may include placing the component 132 on the holder 134, the top surface 98 of the second plate 96, within an opening 140, or a combination thereof. The method may include placing the bag 150 within the collection container 504 and optionally pushing the bag 150 towards the bottom of the collection container 504. The method may include bringing the first and second rings 140, 142 together. The method may include bringing the top and bottom subassemblies 72, 73 together, fitting them together, forming a seal between them. The method may include securing the component 132 between the top and bottom subassemblies 72, 73. The method may include aligning portions of the pressure equalization system 89 such as components of the channel systems 90, 90′, main passages 93, branches 95, openings 92, 92′, and/or grooves 130, 130′ to form an air passageway from the lower chamber 102 to the upper chamber 100 and vice versa.

The method may include activating or powering on the system, drawing dust and debris to the separator 50, removing clean air from the separator 50 into the first portion 502 of the shop vac 500 and separating dust and debris from the air into the collection bag 150 within the collection container 504. The method may include deploying the bag 150 by passing air from the space between the bag 150 and the collection container outer wall 152 via the pressure equalization system 89 to the upper chamber 100.

The method may include deactivating or powering off the system, removing the top subassembly 72 from the bottom subassembly 73, removing the bag retaining component 132 with the bag 150 from the bag assembly 70, removing the collection bag 150 from the collection container 504, removing the bag retaining component 132 from the bag 150, and disposing of the bag 150. The method may include installing a new bag 150 as was described herein.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A particulate matter separation system comprising:
a particulate matter collection container defining a lower chamber;
a particulate matter separator inside of a housing defining an upper chamber; and
a bag assembly attachable to the collection container and the housing, the bag assembly comprising a body having a pressure equalization system structured as a labyrinth of channels internal to the body, the labyrinth communicating with one or more openings in the lower chamber and one or more openings in the upper chamber.

2. The system of claim 1, wherein the separator is a cyclonic separator.

3. The system of claim 1, wherein the body includes a set of coordinating concentric rings which cooperate with one another to form the labyrinth.

4. The system of claim 1 further comprising a collection bag secured within the bag assembly.

5. The system of claim 1 further comprising a shop vacuum motor head attachable to the housing.

6. The system of claim 1 further comprising one or more filters within the upper chamber.

7. The system of claim 1, wherein the body of the bag assembly includes a support for the separator.

8. The system of claim 1, wherein the body of the bag assembly includes a top subassembly compatible with a bottom subassembly, the subassemblies being repeatedly separable.

9. A bag assembly comprising:
a body securable to a vacuum system, the body having an upper surface and a lower surface, the surfaces each having an opening and the body having a pressure equalization system comprising one or more channels communicating with the openings; and
a bag retaining component securably adjacent to the body and configured to secure a collection bag within the assembly when the bag retaining component is secured to the body.

10. The assembly of claim 9, wherein the opening extends into a vertical channel.

11. The assembly of claim 10, wherein the vertical channel extends into a horizontal channel.

12. The assembly of claim 9, wherein the system of channels includes one or more grooves.

13. The assembly of claim 9, wherein the body comprises at least two body portions, each body portion has a channel portion aligned with the other channel portion to form at least a portion of the one or more channels.

14. The assembly of claim 9, wherein the body forms a unitary piece free of seals or fasteners.

15. The assembly of claim 9 further comprising one or more seals.

16. A particulate matter separation system comprising:
a particulate collection container with an open top forming a lower chamber;
an insert removably attachable to the collection container, the insert defining an upper chamber, the insert housing a particulate matter separator having a separator plate at a bottom portion of the particulate matter separator such that the separator plate divides the lower chamber from the upper chamber; and
a shop vacuum motor portion removably attachable to a top portion of the insert.

17. The system of claim 16 further comprising:
a collection bag; and
a bag assembly attachable between the collection container and the insert, the bag assembly comprising a body having a pressure equalization system structured as a labyrinth of channels internal to the body and a component configured to secure the collection bag within the assembly.

18. The system of claim 16, wherein the particulate matter separator forms an integral part of the insert such that the insert's housing forms at least some portions of the separator.

19. The system of claim 16 further comprising one or more seals to provide an airtight system.

20. The system of claim 16, wherein the insert comprises one or more filters.
